(19) United States
(12) Patent Application Publication
(10) Pub. No.: US 2010/0102988 A1
(43) Pub. Date: Apr. 29, 2010

(54) DRIVING CONDITIONS MONITORING DEVICE AND METHOD THEREOF

(75) Inventor: CHIU-HAO CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/512,366

(22) Filed: Jul. 30, 2009

(30) Foreign Application Priority Data
Oct. 28, 2008 (CN) 200810305260.4

(51) Int. Cl. G08G 1/09

(52) U.S. Cl. 340/905

(57) ABSTRACT

A driving conditions monitoring device includes an image capturing unit, a data processing unit, a control unit, and an abnormality processing unit electronically connected in series. The image capturing unit includes at least two image capturing devices to respectively obtain the image of the expression of the drive and the driving road condition. The data processing unit obtains the image information form the image capturing unit, and then sends it to the control unit after processed. The control unit judges whether the states of the driver is normal or abnormal according to the image information of the expression of the drive and the driving road condition, and activates the abnormality processing unit to deal with the abnormality when the state of the driver is abnormal.

### BACKGROUND

1. Technical Field

The present disclosure generally relates to driving conditions monitoring devices, particularly to a driving conditions monitoring device with function of alerting the driver of abnormalities in driving conditions and a method thereof.

2. Description of Related Art

With development of motor vehicles, the amount of vehicles on the streets increases rapidly, and so does the amount of traffic accidents. Safety and security of automobiles and passengers have become an important issue for vehicles makers and local government. As such, new vehicle safety technologies such as braking control, remote speed sensing and etc., have been introduced in vehicles to minimize the risk of accidents. However, sometimes accidents happen because of abnormal driving conditions of drivers which prevent drivers from safely operating a vehicle.

Therefore, there is room for improvement within the art.

### BRIEF DESCRIPTION OF THE DRAWINGS

Many aspects of the driving conditions monitoring device and a method thereof can be better understood with reference to the following drawings. The components in the drawings are not necessarily drawn to scale, the emphasis instead being placed upon clearly illustrating the principles of the driving conditions monitoring device with function of alarming the driver in abnormal driving conditions and a method thereof.

FIG. 1 shows a block diagram of a driving conditions monitoring device with an exemplary embodiment.

FIG. 2 shows a flow chart of a monitoring driving conditions process of the driving conditions monitoring device shown in FIG. 1.

### DETAILED DESCRIPTION

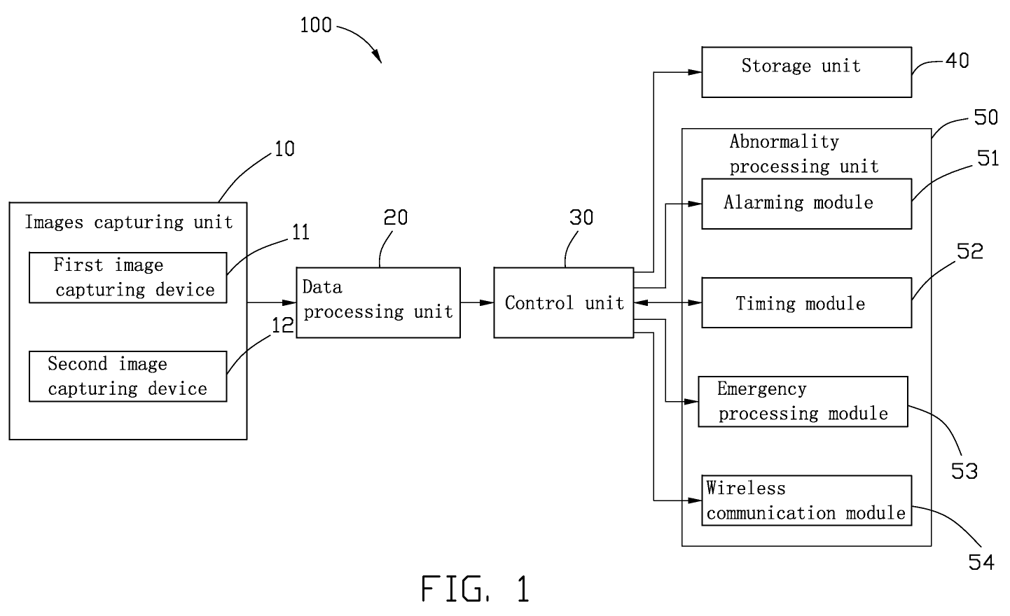

Referring to FIG. 1, a driving conditions monitoring device 100 includes an image capturing unit 10, an data processing unit 20, a control unit 30, a storage unit 40, and an abnormality processing unit 50. The image capturing unit 10, the image data processing unit 20, and the control unit 30 are electronically connected in series. The storage unit 40 and the abnormality processing unit 50 are electronically connected to the control unit 30.

The image capturing unit 10 includes a first image capturing device 11 and a second image capturing device 12. Each of the first image capturing device 11 and the second image capturing device 12 may be a digital camera or a video camera. The first image capturing 11 is arranged facing the face of the driver to obtain expression images of the driver. The second image capturing 12 is arranged towards the front of the vehicle facing the road to obtain the image of the road conditions.

The data processing unit 20 processes the image information received from the image capturing device 10 by converting the received image information to digital image information for the control unit 30.

The control unit 30 judges whether the driving condition of the driver is normal or not based on the processed image information of the expression of the driver and the road condition obtained from the data processing unit 20. For example, the control unit 30 analyzes a portion of expression information of the driver, such as eyes closure time or the frequency of eyes blinking, and the road condition such as the frequency of the vehicle running over the traffic lines. The control unit 30 divides the driving conditions of driver to several abnormal levels and controls the abnormality processing unit 50 to deal with the abnormal state of the driver correspondingly.

The storage unit 40 stores the processed image information of the expression of the driver and the road condition from the control unit 30.

The abnormality processing unit 50 includes an alarming module 51, a timing module 52, an emergency processing module 53, and a wireless communication module 54. The alerting module 51 is connected to the control unit 30. The alerting module 51 generates an alerting signal (e.g. sounds, light indications, etc) to the driver when the control unit 30 acknowledges that the driver is in an abnormal state and cannot safely operate a vehicle. The alerting module 51 has preset several different alerts according to the different abnormal levels of the driving condition of the driver.

The timing module 52 has preset a time (e.g. 5 minutes, 6 minutes, etc) therein to control an alerting time of the alerting module 51. If the preset time of the timing module 52 has reached, and the driving condition of the driver is still abnormal and cannot safely operate the vehicle, the timing module 52 sends a signal to the control module 30 to activate the emergency processing module 53 or the wireless communication module 54.

The emergency processing module 53 is connected to an engine control unit (ECU) (not shown) mounted in the vehicle. When the emergency processing module 53 receives signal from the timing module 52 indicating that the driver condition of the driver is in abnormal state, the emergency processing module 53 sends a stop signal to the ECU. The stop signal may be used to switch the vehicle to an automatic drive mode, which allows the vehicle to break and come to a stop.

The wireless communication module 54 can communicate with other predetermined communication terminals such as a local police station, and has predetermined phone numbers of the communication terminals stored therein. When the wireless communication module 54 receives signal from the timing module 52 indicating that driver condition of the driver is in abnormal state, the wireless communication module 54 communicates with the predetermined communication terminals for help by sending a message or making a call.

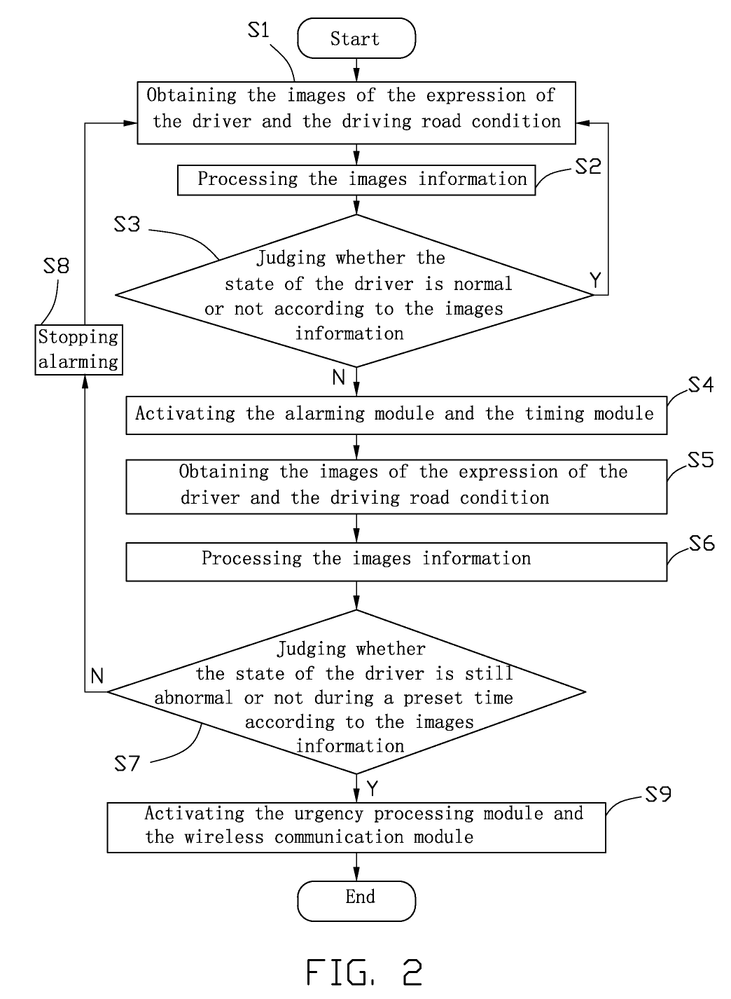

Referring to FIG. 2, the process of the monitoring driving conditions method may include the following steps:

In step S1, the image capturing unit 10 obtains expression images of the driver and road conditions, and sends the image information to the data processing unit 20.

In step S2, the data processing unit 20 obtains the image information from the image capturing unit 10, and processes the image information by converting the image information into digital image information for the control unit 30.

In step S3, the control unit 30 judges whether the driving condition of the driver is normal or not according to the image information of the expression of the driver and the driving road condition, if no, the process goes to step S4, if yes, the process returns back to step S1.

In step S4, the control unit 30 activates the alerting modules 51 and the timing modules 52. The alerting module 51 generates an alerting signal to the driver. The timing module 52 has preset a time therein to control an alerting time of the alarming module 51.

In step S5, the image capturing unit 10 obtains the expression images of the driver and the driving road condition, and sends the image information to the data processing unit 20.

In step S6, the data processing unit 20 obtains the image information from the image capturing unit 10, and then processes the image information by converting the image information into digital image information for the control unit 30.

In step S7, the control unit 30 judges whether the driving condition of the driver is still abnormal or not during the preset time according to the image information of the expression of the drivers and the driving road, if no, the process goes to step S8, if yes, the process goes to step S9.

In step S8, the control unit 30 controls the alerting modules 51 to stop alerting, and the process returns back to step S1.

In step S9, the control unit 30 activates the emergency processing module 53 to switch the vehicle to an automatic drive mode, allowing the vehicle to brake and come to a stop. At the same time, the control unit 30 activates the wireless communication module 54 to communicate with a predetermined communication terminal for help.

In another embodiment, the image capturing unit 10 may include more than two image capturing devices to obtain the image of the expression of the driver and the driving road condition for the data processing unit 20. The driving conditions monitoring device 100 obtains expression image of the driver and the road condition via the image capturing unit 10, and judges whether the driving condition of the driver is normal or not according to the image information by the control unit 30, and generates an alerting signal to the driver when the driver is in abnormal driving condition, to effectively avoid traffic accident.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A driving conditions monitoring device, comprising:
an image capturing unit including at least two image capturing devices to respectively obtain the images of the expression of the driver and the driving road conditions,
a data processing unit;
a control unit; and
an abnormality processing unit; wherein the image capturing unit, the data processing unit, the control unit, and the abnormality processing unit are electronically connected in series, the data processing unit obtains the image information from the image capturing unit, and then sends it to the control unit after processed, the control unit judges whether the states of the driver is normal or abnormal according to the image information of the expression of the drive and the driving road condition, and activates the abnormality processing unit to deal with the abnormality when the state of the driver is abnormal.

2. The driving conditions monitoring device as claimed in claim 1, wherein the abnormality processing unit includes an alarming module and a timing module both connected to the control unit, the alarming module generates an alarm for the driver when the control unit judges the driver is in an abnormal state, the timing module has preset a time therein to control an alarming time of the alarming module.

3. The driving conditions monitoring device as claimed in claim 2, wherein the abnormality processing unit further includes an emergency processing module connected to the control unit to switch the vehicle to an automatic drive mode when the control unit judges the driver is in an abnormal state after the preset time.

4. The driving conditions monitoring device as claimed in claim 2, wherein the abnormality processing unit further includes a wireless communication module having predetermined phone numbers of the communication terminals therein, the wireless communication module is connected to the control unit to communicate with the predetermined communication terminals for help when the control unit judges the driver is in an abnormal state after the preset time.

5. A driving conditions monitoring method, comprising:
obtaining an image of the expression of the driver and the driving road condition;
processing the image information;
judging whether the state of the driver is normal or abnormal according to the processed image information of the expression of the drivers and the driving road; and
if the state of the driver is abnormal, generating an alarm signal for the driver.

6. The driving conditions monitoring method as claimed in claim 5, further comprising controlling the alarming time within a preset time when generating an alarm for the driver.

7. The driving conditions monitoring method as claimed in claim 6, further comprising obtaining the image of the expression of the driver and the driving road condition, processing the image information, judging whether the state of the driver is normal during the preset time according to the image information of the expression of the driver and the driving road, and stopping alarming when the state of the driver is normal.

8. The driving conditions monitoring method as claimed in claim 7, further comprising communicating with predetermined communication terminals for help when the state of the driver is abnormal after the preset time.

9. The driving conditions monitoring method as claimed in claim 7, further comprising switching the vehicle to an automatic drive mode when the control unit judges the driver is in an abnormal state after the preset time.
